(19) United States
(12) Patent Application Publication
(10) Pub. No.: US 2009/0007989 A1
(43) Pub. Date: Jan. 8, 2009

(54) METAL BATH FLUX AND METHOD TO TREAT METAL BATH FLUX AND METHOD TO PRODUCE A METAL BATH FLUX

(75) Inventor: Volker Ohm, Stolberg (DE)

Correspondence Address: COLLARD & ROE, P.C., 1077 NORTHERN BOULEVARD, ROSLYN, NY, 11576, US

(73) Assignee: HOESCH METALLURGIE GMBH, Niederzier (DE)

(21) Appl. No.: 11/965,920

(22) Filed: Dec. 28, 2007

Related U.S. Application Data
(60) Provisional application No. 60/878,009, filed on Dec. 29, 2006.

(30) Foreign Application Priority Data
May 31, 2007 (DE) 10 2007 025 602.9

(51) Int. Cl. B23K 35/34

(52) U.S. Cl. 148/24

(57) ABSTRACT

A metal bath flux as well as a method for the treatment of a metal bath and a method for the production of includes at least two separate solid components having a first component and a second component. With the separate solid components, it is possible to supply them to the bath together, and nevertheless to allow them to become effective at different points in time or at different locations by taking advantage of their different melting points or their different grain sizes.

### CROSS REFERENCE TO RELATED APPLICATIONS

Applicants claim priority under 35 U.S.C. §119(e)(1) and the benefit of copending U.S. Provisional Application Ser. No. 60/878,009 entitled “Metal bath flux, method to treat a metal bath and method to produce a metal bath flux” filed Dec. 29, 2006 which is incorporated by reference herein. Applicants also claim priority under 35 U.S.C. §119 of German Application No. DE 10 2007 025 602.9 filed May 31, 2007.

### BACKGROUND OF THE INVENTION

1. Field of the Invention

The present invention relates to a metal bath flux, its use, as well as a method for the treatment of a metal bath and a method for the production of a metal bath flux.

2. The Prior Art

It is known to subject metal baths to purification treatment in order to remove contaminants from the metals, whereby the metals are then subsequently disposed of or passed to further treatment. In this connection, sodium (Na), calcium (Ca), or lithium (Li)—if lithium fluoride (LiF), a corresponding aluminum electrolyte, was supplied—are removed from aluminum (Al), for example, by means of chlorine gas. However, the use of chlorine gas is hazardous and harmful for the environment, and for these reasons, it is frequently prohibited. Instead of chlorine gas, solid metal fluxes are now introduced into the metal baths, for example by blowing them in, which remove contaminants. For example, Na, Ca, Li, or H contaminants can easily be removed from Al baths, by means of magnesium chloride (MgCl₂), calcium chloride (KCl), or mixtures of them. However, any scab that forms in this connection is relatively wet, i.e. it contains a high proportion of aluminum, so that aluminum purification is achieved however with relatively high Al losses.

Furthermore, it is known to subsequently apply scab-remover salts to the scab, which generally contain fluorides, for example CaF₂, which then remove aluminum from the scab again. However, this is only possible to a certain degree and generally also leads to a re-introduction of the removed contaminants, such as calcium. Similar problems are also known for other metal baths, for example magnesium baths, whereby other solid metal bath fluxes are used.

### SUMMARY OF THE INVENTION

It is therefore an object of the present invention to make a solid metal bath flux, provide methods for the treatment of a metal bath, and for the production of a metal bath flux, which are able to remove contaminants from metal baths in a similarly reliable manner as in the case of the known solid metal bath fluxes, without removing too much of the corresponding metal or introducing new contaminants.

The present invention advantageously achieves this by proposing a solid metal bath flux that comprises at least two separate solid components. With the separate solid components, it is possible to supply them to the bath together, and nevertheless to allow them to become effective at different points in time or at different locations.

“Separate solid components” is to be understood to mean that such components can be separated from one another without any transition into a different aggregate state or without chemical intervention. For example, such components can react in the bath to the desired extent, while still in the solid state, whereby the components can be separated in the melt and distributed accordingly. Then, the distribution can take place by means of flows in the bath or, on the other hand, external influences, such as electric or magnetic fields, gravitation, or similar forces. It is not necessary to achieve a homogeneous distribution, but rather different distributions in the metal bath can also be practical. It is also possible that although the two components are connected with one another, for example caked together due to extended storage, they separate due to stress when they are blown in or when directly introduced into the metal bath, without changing their aggregate state during separation. For example, it is possible that these components are present as solid components, even in the metal bath, at least for a short time.

As is directly evident, the present invention can achieve a corresponding purification capacity as in the case of known metal bath fluxes, since identical components can easily be used in this regard. On the other hand, the present invention can also be configured for other purposes, for example for removing non-metallic contaminants and forming as dry a scab as possible. Also, components can be provided to the present invention for the purpose of forming the scab in such a manner that it can be easily removed from the metal bath surface.

Second of all, the present invention proposes a method for the treatment of a metal bath, in which a solid metal bath flux is applied to the metal bath, and which is characterized in that at least two separate solid components of the metal bath flux are mixed before application, and subsequently jointly applied to the metal bath.

Such a method of procedure is significantly more economical than conventional methods, since only one application step for the metal bath flux is provided, so that the corresponding method can be carried out with extreme operational reliability. This is particularly true for treatment methods in which the metal bath flux is blown in, since it is only necessary to carry out the latter step once in order to introduce both of the components into the metal bath, and therefore it is possible to otherwise do without introduction or application steps in this regard, so that the metal bath can be directly processed further or also can be refilled into a different container.

It should be mentioned that in the present case, the term “metal bath” is understood to mean any melt of a metal in which a major portion of the metal is present in liquid form, and only a small part is present in solid form, for example as an ingredient of a scab or as an ingredient of slag. In particular, liquid metal streams are therefore also referred to as metal baths.

Third of all, the present invention proposes a method for the production of a metal bath flux comprising at least two separate solid components of the metal bath flux which are mixed with one another, in separable manner, so that a metal bath flux comprising at least two separate solid components, having the advantages indicated above, is made available.

Preferably, the metal bath flux comprises a granulate having at least two components, whereby in particular, each of the separate solid components of the metal bath flux can represent a component of the granulate. Particularly for production, the ingredients of at least one of the components can be firmly connected with one another to form ingredient bodies, which are then granulated.

Such a granulate has sufficient inherent stability, so that it can easily be supplied to a metal bath, for example by way of a fan. Likewise, storage over an extended period is easily possible, since granulates are relatively chemically stable and can easily be protected against outside influences.

Preferably, this method can take place in the case of both components, whereby the ingredient bodies of both components can also be granulated jointly, if necessary.

The ingredient bodies can be made available in any suitable manner. For example, it is possible to melt individual ingredients with one another, and to granulate a body that has solidified again. Ingredient bodies can also be obtained from liquid solutions, for example by cultivating crystals or by recrystallization. Corresponding ingredient bodies can also be made available by means of sintering processes.

Preferably, at least one component of the metal bath flux is a salt. In particular, the metal bath flux, as a whole, can be a salt mixture, in which each of the mixed salts represents a component of the metal bath flux. Salts can be processed and introduced into a metal bath in a particularly simple manner, in accordance with the procedures explained above and below. Furthermore, they represent relatively stable states of the components of the metal bath flux, so that they can be stored even over an extended period of time.

In a preferred embodiment, the two components of the metal bath flux have a different melting point. In this way, the components become effective in the metal bath at different points in time, although they are essentially introduced into the metal bath at the same time. Thus, for example, one component can have a melting point between 350° C. and 750° C., preferably a melting point between 400° C. and 500° C., and the other component can have a melting point between 450° C. and 800° C., preferably a melting point between 600° C. and 700° C.

Aside from the fact that the chemical composition as well as the crystal structure essentially determine the melting point, the process with which the components react with the metal bath can also be influenced by means of the grain size of the components. For example, larger solid bodies need longer to react with the bath than smaller solid bodies that are otherwise identical. In this regard, it is advantageous if the two components have different grain sizes, if necessary.

It is understood that the grain sizes of a component can vary within a certain band width. Preferably, this lies between 0 mm and 6 mm, particularly between 0.5 mm and 4 mm, or between 0.8 and 3 mm. In this connection, it is understood that grain sizes are generally present in distributions, for example in Gaussian distributions. If the grain size is defined by way of screenings, then the distribution is generally set to zero, almost inconstantly, above a specific value, since grains above a certain size cannot get through a screen. Likewise, microparticles in dust form are present in a mixture, but they generally lead to undesirable results in the present invention, since they react with the metal bath in direct and uncontrolled manner. Such dust or microparticles are considered to be unimportant for the grain sizes in the present case.

On the other hand, the occurrence of such dust, particularly that caused by subsequent friction wear, can be minimized by means of a sufficient strength of the components. It is advantageous if the components produce only a defined amount of friction wear in a friction-wear test, which amount preferably lies below 20%, particularly below 10%, 5%, or 3%, respectively, measured in accordance with the following measurement method.

First, in order to determine a starting grain distribution, 150 g to 200 g are applied to an uppermost screen of a screen tower of a screening machine, HAVER EML 200 digital T from the Haver company. A screen interval having the value 5—at a maximum of the value 9—is set at the screening machine, corresponding to approximately one minute. The intensity is also set at the value 5—at a maximum of the value 9. The entire duration of screening, including the pauses, then takes approximately ten minutes. Afterwards, the amounts of the different screen fractions are weighed out in order to determine the starting grain distribution. In order to determine the grain distribution after a defined mechanical stress, the screen interval is set to 0, which corresponds to continuous screening. The intensity is set to the maximum, in other words the value 9. The entire screening period then takes approximately forty minutes. Subsequently, the screening fractions are weighed out again. The friction wear is determined from the fines, which collect in addition, according to the starting value (=100*(fines−fines_{starting grain distribution}/fines_{starting grain distribution}), and should preferably lie below 20%, as already stated above.

Preferably, a fines proportion or microparticle proportion of less than 10%, particularly of less than 5%, 3%, or 1%, respectively, should be found in the starting material with a corresponding measurement structure. As already mentioned above, such a microparticle proportion, such as corresponding dust, is not good for the present invention.

Preferably, the strength and/or the proportion of microparticles of the two components are essentially the same, so that the two components can be subjected to the same mechanical stresses, such as when they are blown in.

It can be assured by means of a proportion of water of crystallization of at least one of the components below 5%, preferably below 1%, particularly below 0.5%, that hydrogen H, in particular, is not unnecessarily entrained into the metal bath. Water of crystallization can be determined in accordance with the method of “titration according to Karl Fischer,” for example, in that a volumetric Karl Fischer titration is carried out using common standard parameters. Subsequent penetration of water of crystallization can be minimized even in the case of extended storage periods, by means of known measures, such as moisture-tight storage. In general, short-term exposure, particularly immediately before blowing in, is not critical, since the penetration of water of crystallization generally takes a longer time. Under some circumstances, however, even short-term exposure can be avoided with known measures, for example by working in a moisture-proof environment. It is understood that the proportion of water of crystallization, the grain size distribution, and the strength demonstrate the corresponding advantages even independent of the other characteristics of the present invention.

In a preferred embodiment, one of the components comprises ingredients of earth alkali and/or alkali chlorides, if necessary with the addition of fluorides, particularly of earth alkali and/or alkali fluorides. Particularly preferably, one of the components is made available from ingredients of magnesium (Mg), barium (Ba), strontium (Sr), and/or calcium (Ca) chloride. As an additive, Sodium (Na) chloride and/or potassium (K) chloride as well as potassium (K) and/or calcium (Ca) fluoride can also be added, for example.

Preferably, the second of the two components comprises ingredients of fluorides and alkali chlorides, if necessary with the addition of earth alkali chlorides. Also, the second of the two components can have ingredients of earth alkali fluorides, aluminum fluoride, and/or double salts of them, whereby alkali fluorides can be added, if necessary.

Alternatively or cumulatively to this, at least a second of the two components can contain carbonates, sulfates, and/or nitrates, particularly alkali and/or earth alkali carbonates, sulfates, and/or nitrates, of the alkali and/or earth alkali metals contained in this component. In this way, the scabbing behavior of this component can also be influenced in targeted manner.

It is understood that the compositions described above can be advantageous and independent of the other characteristics of the present invention, in order to be able to suitably purify metal baths, particularly aluminum baths. However, the compositions can become active successively in the metal bath, particularly by means of the present invention, so that counter-current effects can be avoided and the purity of the metal can be improved by means of the time sequence—or also by means of an effect at different locations.

In order to ensure the effectiveness of the individual components, it is advantageous if these are present at not less than 5% in the metal bath flux, in each instance. In this manner, it is ensured that the first of the two components can be present at a proportion between 5% and 95%, while the other of the two components can form the rest of the metal bath flux.

It is understood that the present invention can be advantageously used not only for Al baths but also for other metal baths, particularly also for Mg baths.

### DETAILED DESCRIPTION OF THE PREFERRED EMBODIMENTS

According to one embodiment of the invention, MgCl₂ and KCl are melted together in a ratio of 60% to 40% and granulated. The granulate has a melting point between 440° C. and 480° C., and forms the first component of a corresponding metal bath flux. Depending on the requirements, fluorides, particularly CaF₂ or KF, can also be added to the first component. For the second component, KCl and AlF₃ and/or K₃AlF₆ are connected with one another and granulated. This granulate has a melting point at approximately 600° C.

Subsequently, the two granulates are mixed to produce the metal bath flux according to the invention. The grain size of the two granulates lies between 0.8 mm and 3 mm, and is essentially the same for the two granulates in the case of this embodiment, with essentially the same distribution. The proportion of microparticles, in other words particles below 0.8 mm, is lowered to below 1%, whereby the strength of the two components is selected in such a manner that only 1% more microparticles can be found in the lower screen after three times 10 minutes vibration, with a one-minute pause, in each instance, in a screen tower from Haver & Böcker, at the highest amplitude. The proportion of water of crystallization, particularly also of the component that contains MgCl₂, was lowered to less than 0.5%.

The following chemical compositions can be made available as components, accordingly:

| Component A | Component B |
|---|---|
| 60% MgCl₂/40% KCl | 90% KCl/10% AlF₃ |
| 40% MgCl₂/60% KCl | 10% NaCl/10% AlF₃/80% KCl |
| 36% MgCl₂/54% KCl/10% CaF₂ | 5% K₂SO₄/15% K₃AlF₆/80% KCl |

The following grain distributions are advantageous:

| Component A | Component B |
|---|---|
| 0.4-1.5 mm | 1.5-2.5 mm |
| 0.8-3.0 mm | 0.8-3.0 mm |
| 1.0-2.5 mm | 2.0-3.0 mm |

This metal bath flux can then be blown into an aluminum bath. It turns out that the scab made available by this metal bath flux is relatively dry and can easily be removed. The purity of the aluminum is excellent and corresponds at least to the purity of an aluminum bath that was treated with a conventional metal bath flux, such as a mixture of MgCl₂ and KCl, for example, but with this metal bath flux according to the state of the art, losses of aluminum are recorded.

Although at least one embodiment of the present invention has been shown and described, it is apparent that many changes and modifications may be made thereunto without departing from the spirit and scope of the invention.

What is claimed is:

1. A solid metal bath flux comprising at least two separate solid components.

2. The metal bath flux according to claim 1, wherein the metal bath flux consists of a granulate.

3. The metal bath flux according to claim 2, wherein each of the separate solid components of the metal bath flux forms a component of the granulate.

4. The metal bath flux according to claim 1, wherein at least a first one of said two components contains alkali or earth alkali ions.

5. The metal bath flux according to claim 1, wherein at least a first one of said two components contains Cl or F ions.

6. The metal bath flux according to claim 4, wherein the first component contains alkali or earth alkali chlorides.

7. The metal bath flux according to claim 6, wherein the first component contains K or Ca fluorides.

8. The metal bath flux according to claim 1, wherein at least a second one of the two components contains alkali or earth alkali ions.

9. The metal bath flux according to claim 1, wherein at least a second one of the two components contains aluminum ions.

10. The metal bath flux according to claim 1, wherein at least a second one of the two components contains Cl or F ions.

11. The metal bath flux according to claim 8, wherein the second component contains fluorides and alkali chlorides.

12. The metal bath flux according to claim 9, wherein the second component contains aluminum fluorides.

13. The metal bath flux according to claim 11, wherein the second component contains earth alkali fluorides, aluminum fluorides, or double salts of earth alkali fluorides or aluminum fluorides.

14. The metal bath flux according to claim 11, wherein the second component contains earth alkali chlorides.

15. The metal bath flux according to claim 1, wherein at least a second one of the two components contains carbonates, sulfates or nitrates.

16. The metal bath flux according to claim 8, wherein the second component contains alkali or earth alkali carbonates, sulfates or nitrates.

17. A method for the treatment of a metal bath, comprising:
mixing at least two separate solid components of a metal bath flux; and
subsequently applying the solid metal bath flux containing the mixed components to the metal bath.

18. The method according to claim 17, wherein the metal bath flux is blown into the metal bath.

19. The method according to claim 17, wherein the metal bath is an Al bath.

20. The method according to claim 17, wherein the metal bath is an Mg bath.

21. A method for the production of a metal bath flux, comprising mixing at least two separate solid components of the metal bath flux with one another, in a separable manner.

22. The method according to claim 21, wherein ingredients of at least one of the two components are first firmly bonded with one another to produce ingredient bodies, and then said ingredient bodies are granulated, separately or together.

23. The method according to claim 21, wherein at least one of the components of the metal bath flux is a salt.

24. The method according to claim 23, wherein each component of the metal bath flux is a salt and said component are mixed to form a salt mixture.

25. The metal bath flux according to claim 1, wherein the two components have different melting points.

26. The metal bath flux according to claim 25, wherein a first one of the two components has a melting point between 350° C. and 750° C., and the other of the two components has a melting point between 450° C. and 800° C.

27. The metal bath flux according to claim 1, wherein the two components have different grain sizes.

28. The metal bath flux or method according to claim 1, wherein at least one of the components has a grain size of less than 6 mm.

29. The metal bath flux according to claim 1, wherein at least one of the components has a grain size of greater than 0.5 mm.

30. The metal bath flux according to claim 1, wherein the components have a friction wear of less than 20%.

31. The metal bath flux according to claim 32, wherein the friction wear of the two components is essentially the same.

32. The metal bath flux according to claim 1, wherein the components have a microparticle proportion of less than 10% by weight.

33. The metal bath flux according to claim 1, wherein at least one component of the metal bath flux has a proportion of water of crystallization of less than 5% by weight.

34. The metal bath flux according to claim 1, wherein each one of the two components is present in the metal bath flux at a proportion of not less than 5% by weight.
